(19) United States
(12) Patent Application Publication
(10) Pub. No.: US 2014/0057793 A1
(43) Pub. Date: Feb. 27, 2014

(54) METHOD OF SIMULTANEOUSLY EVALUATING MULTIPLE GENOMIC SEQUENCES

(71) Applicant: Real Time Genomics, Inc., San Bruno, CA (US)

(72) Inventors: John Gerald CLEARY, Hamilton (NZ); Sean A. Irvine, Hamilton (NZ); Kurt Oliver Gaastra, Hamilton (NZ); Leonard Eric Trigg, Ngahinapouri (NZ)

(73) Assignee: Real Time Genomics, Inc., San Bruno, CA (US)

(21) Appl. No.: 13/971,654

(22) Filed: Aug. 20, 2013

Related U.S. Application Data
(60) Provisional application No. 61/691,271, filed on Aug. 21, 2012.
(60) Provisional application No. 61/729,462, filed on Nov. 23, 2012.
(60) Provisional application No. 61/803,671, filed on Mar. 20, 2013.

(51) Int. Cl. G06F 19/22

(52) U.S. Cl. CPC G06F 19/22
USPC 506/2; 702/19

(57) ABSTRACT

Methods and systems for simultaneously evaluating genomic sequences across multiple population members, and methods and systems for simultaneously calling normal and cancerous genomic sequences from a mixed sample containing normal and cancerous material are disclosed. This may be achieved by evaluating the probability of one or more hypothesis being correct for a plurality of population members based on genomic sequence information for the population. For related family members, Mendelian inheritance may be integrated into the method. For populations, information from members under evaluation may be used to refine priors to more accurately call population members. Copy number variation and de novo mutations may also be accommodated in the methods. Specific systems for implementing the methods are also disclosed.

### CROSS-REFERENCE TO RELATED APPLICATIONS

This application claims priority to U.S. Provisional Application No. 61/691,271, filed Aug. 21, 2012; U.S. Provisional Application No. 61/729,462, filed Nov. 23, 2012; and U.S. Provisional Application No. 61/803,671, filed Mar. 20, 2013; all of which are incorporated by reference herein.

The inventions described herein relate to methods for simultaneously evaluating genomic sequences, including cancer-related sequences, and systems therefor. The methods and systems additionally may incorporate Mendelian inheritance among related family members. The inventions also relate to probability-based calling methods suitable for use in calling sequences for reads obtained from samples containing both normal and cancerous material. There are also disclosed methods incorporating copy number variation into probability-based calling methods.

There have been great advances in genomic sequencing in recent times. Sequencing machines can generate reads ever more rapidly with increasingly accurate results. However, there remain errors in the reads produced and during the process of read alignment the reads must be assembled as best as possible to generate the most accurate genomic sequence for the sample possible. The process of “calling” a value of the sequence from the reads requires consideration of a range of relevant factors and potential sources of errors.

Additionally, there has been much research to identify predisposing genomic sequence variants and somatic mutations. The basis for this research is the accurate calling of cancerous sequences obtained from tumors and related samples. However, many samples have included a mixture of normal genomic sequences and cancerous genomic sequences and the quality of calling has been reduced for such mixed samples as the reads for the normal samples act as contamination of the cancerous samples.

A wide range of algorithms for calling sequence values have been employed. Some use filtering techniques but this potentially loses information that may assist in making a call or values that upon more thorough investigation may be the best calls. Mendelian inheritance rules have been used to investigate family relationships but have not been incorporated into an integrated model for simultaneously evaluating multiple population members. Prior approaches have looked to other family members as data rather than as part of a larger dynamic model. Such approaches have had limited success in correctly identifying the likelihood of de novo mutations.

Other techniques for calling biological sequences include the applicant's prior U.S. Pat. No. 7,640,256 and U.S. application Ser. Nos. 13/129,329 and 61/695,408, and PCT/NZ2011/000080, PCT/NZ2011/000081 and PCT/NZ2011/000197 which are hereby incorporated by reference.

Prior calling techniques typically assume that the sample is uncontaminated (i.e. either all normal or all cancerous material) and have not been able to make accurate calls for mixed samples of cancerous and normal biological material or where there is copy number variation (which is common with cancer).

It would be desirable to improve the quality of calling by utilizing population information in an integrated model. It would also be desirable to improve the quality of calling for mixed samples or where there is copy number variation.

It is an object of the disclosed inventions to provide improved methods of calling biological sequences that overcome at least some of these problems or to at least provide the public with a useful choice.

In some embodiments, the invention provides a method of calling a genomic sequence for a sample from a biological entity in a collection of related biological entities, performed by one or more processors executing program instructions stored on one or more memories, causing the one or more processors to perform the method comprising:
a. obtaining genomic sequence information for one or more samples from one or more biological entities;
b. performing read alignments to generate preliminary alignments for the samples;
c. identifying a region of interest for the alignments;
d. developing hypotheses as to sequence values in the region of interest; and
e. evaluating the probability of one or more hypothesis being correct for a plurality of sequence values based on the genomic sequence information.

In some embodiments, the invention provides a system for calling a genomic sequence for a sample from a biological entity in a collection of related biological entities, the system comprising:

one or more processors configured to execute one or more modules; and a memory storing the one or more modules, the modules comprising:
a. code for obtaining genomic sequence information for one or more samples from one or more biological entities;
b. code for performing read alignments to generate preliminary alignments for the samples;
c. code for identifying a region of interest for the alignments;
d. code for developing hypotheses as to sequence values in the region of interest; and
e. code for evaluating the probability of one or more hypothesis being correct for a plurality of sequence values based on the genomic sequence information.

In some embodiments, the invention provides a method of calling a genomic sequence for a sample from a subject potentially containing normal and cancerous material, performed by one or more processors executing program instructions stored on one or more memories, causing the one or more processors to perform the method comprising:
a. sequencing the potentially mixed sample of normal and cancerous genomic material to obtain reads for the sample;
b. performing read alignments to generate preliminary alignments for the samples;
c. identifying a region of interest for the alignments;
d. developing hypotheses as to sequence values in the region of interest; and
e. evaluating the probability of normal sequence and cancerous sequence values based on the reads, normal genomic sequence information, and a contamination factor.

Additional objects and advantages of the invention will be set forth in part in the description which follows.

It is acknowledged that the terms “comprise,” “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

It is to be understood that both the foregoing general description and the following detailed description are exemplary and explanatory only and are not restrictive of the invention, as claimed.

### BRIEF DESCRIPTION OF THE DRAWINGS

Reference will now be made to the accompanying drawings showing example embodiments of this disclosure. In the drawings:

FIG. 1 shows a family diagram modeling a mother, father, and single child, consistent with embodiments of the present disclosure.

FIG. 2 shows a family diagram modeling a mother, father, and four children, consistent with embodiments of the present disclosure.

FIG. 3 shows a model illustrating forward and backward propagation of model values in an exemplary monogamous family, consistent with embodiments of the present disclosure.

FIG. 4 shows a model illustrating forward and backward propagation of model values in an exemplary non-monogamous family, consistent with embodiments of the present disclosure.

FIG. 5 shows a model illustrating the order of execution in the forward backward algorithm as applied to an exemplary non-monogamous family, consistent with embodiments of the present disclosure.

FIG. 6 illustrates exemplary hardware components that can be used to solve or approximate the values of variables represented in certain embodiments, consistent with embodiments of the present disclosure.

FIG. 7 shows a hardware configuration suitable for computing the final normalized probabilities of the hypotheses.

FIG. 8 shows a hardware configuration suitable for computing the A_{c} value for a child in a single-child family. This example takes as inputs the A values and S values for the parents

FIG. 9 is a hardware configuration suitable for computing the Bₘ value for a mother in a single-child family. This example takes as inputs the A values and S values for the father and the child.

FIG. 10 shows a neural network for performing pedigree variant analysis.

### DETAILED DESCRIPTION

When developing a representation of a genomic sequence from a biological sample sequencing machines produce many reads of short portions of the subject genomic sequence (typically DNA, RNA or proteins). These reads (genomic sequence information) must be aligned and then “calls” must be made as to values of the sequence at each location (e.g., individual bases for DNA). There may typically be only a few reads (and sometimes none) at a particular location or very many reads in others.

Errors can arise in process of sequencing genomes. In some cases all reads are consistent or “simple calls” may be made using conventional calling techniques. There are typically “regions of interest” that may span a single or several values where more sophisticated analysis can be required to make a reliable call. A region may be identified as a region of interest, as the confidence in calling the region may be too low using simple calling techniques or there may be characteristics of the region indicating deeper analysis is desirable. These characteristics may be numbers of insertions and/or deletions, the value and proximity of calls (e.g. a number of low confidence calls close to each other) etc.

The problems are compounded when:

(1) The sample includes both genomic information relating to normal and cancerous biological material; and/or

(2) The number of copies of parts of the genomic sequence varies (i.e. in cancerous cells more copies of parts of the DNA may be produced than others—a phenomenon known as copy number variance).

A Bayesian approach may be applied to resolve calls in such regions of interest. This is a principled way of combining multiple factors and allows evolving knowledge to be dynamically integrated.

Such regions of interest can be evaluated without reference to family members or a related population. Such regions of interest can also be evaluated without taking into account contamination (mixed normal and cancerous biological samples) or copy number variation (certain portions of the genomic sequence may have more copies due to a cancer). But the exclusion of family member, related population, and contamination information removes a large volume of information that can assist in making reliable calls in difficult regions. Accordingly, in certain embodiments, the reads for multiple samples may be evaluated simultaneously so that all information is utilized to inform the calling of genomic sequences for each sample and provide more accurate calling. Additionally, in certain embodiments, the model is adjusted to account for contamination and/or copy number variation to improve the accuracy of calling genomic sequences.

In certain embodiments, a Bayesian model can be applied to calling a genomic sequence. For example, the probability of a hypothesis (proposed sequence values for the region of interest) being correct given the data (reads) is the normalized value of the probability of the hypothesis occurring (prior) times the probability of the data occurring given the hypothesis (model) which may be expressed as:

$$P ( H \vert D ) = \frac{P ( H ) \times P ( D \vert H )}{\sum P ( H ) \times P ( D \vert H )} \qquad ( Equation 1 )$$

where:
P(H|D) is the probability of a hypothesis H being correct for all members given data D,
P(H) is the probability of the hypothesis occurring, independent of the data D,
P(D|H) the probability of the data D occurring given the hypothesis, and
ΣP(H)×P(D|H) is the sum of all probabilities for all hypotheses, which is used to normalize the results.

For a population of k members this may be expressed as:

$$P ( H \vert D ) = \frac{P ( \prod {H}_{k} ) \times \prod P ( {D}_{k} \vert {H}_{k} )}{\sum P ( \prod {H}_{k} ) \times \prod P ( {D}_{k} \vert {H}_{k} )} \qquad ( Equation 2 )$$

where:
P(H|D) is the probability of a hypothesis H (consisting of the k sequences hypothesized for the k population members) being correct for all members given data D (being the reads for all k members),
P(ΠHₖ) is the probability of a hypothesis for the k population members occurring, independent of the data D,
ΠP(Dₖ|Hₖ) is the probability of the data D (i.e. the reads for all k members) occurring given the hypothesis (consisting of the k sequences hypothesized for the k population members), and
ΣP(ΠHₖ)×ΠP(Dₖ|Hₖ) is the sum of all probabilities for all hypotheses across all values, which is used to normalize the results.

For a population, an expectation maximization (EM) algorithm may be employed to improve calling accuracy. The algorithm may enhance calling by utilizing population prior information to refine calling. This may be performed by:
(a) calling sequences for population members based on historical probability data as to the probability of a hypothesis occurring;
(b) combining the called sequences for population members with the historical probability data to produce combined historical data;
(c) re-calling sequences for population members based on the combined historical data as to the probability of a hypothesis occurring;
(d) repeating steps (b) and (c) until a desired convergence is achieved.

In step (b) the called sequence information may be combined with the historical probability data based on the probability of a haploid sequence occurring. This may assist in achieving rapid convergence. Alternatively the called sequence information may be combined with the historical probability data based on the probability of a diploid sequence occurring. Steps (b) and (c) may be repeated until there is no change in sequence calling or when some other criteria is met.

Mendelian Inheritance

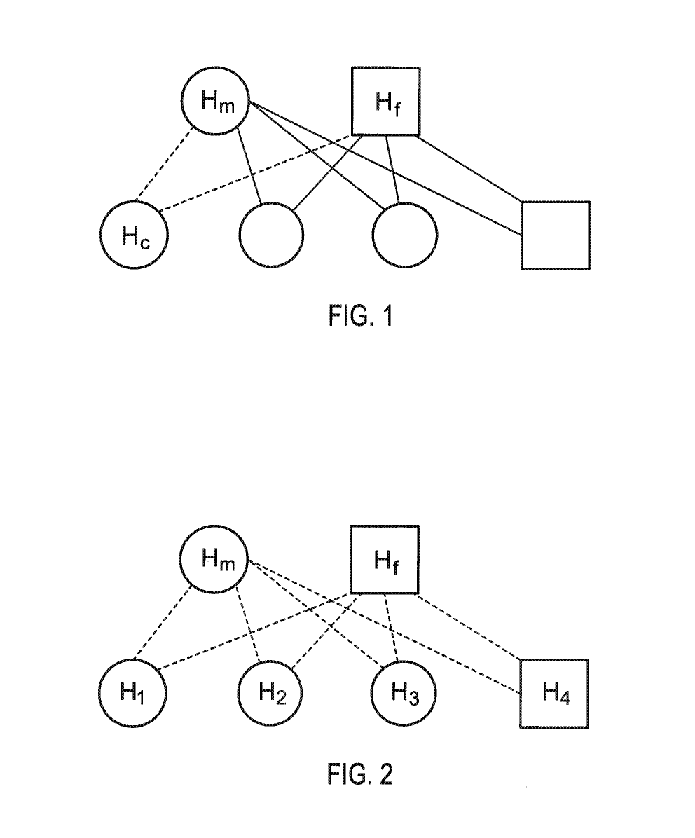

In certain embodiments, where a family is being evaluated, such as illustrated in FIG. 1, Mendelian inheritance information may be incorporated into the model. Applying Equation 2 to a nuclear family of a mother (m) a father (f) and a child (c), it becomes:

$$\begin{matrix}P ( H \vert D ) = \frac{\begin{matrix}P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}}{\begin{matrix}\sum P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}} \\ which may be re \text{-} expressed as \text{:} & ( Equation 3 ) \\ P ( H \vert D ) = \frac{\begin{matrix}\begin{matrix}P ( {D}_{m} \vert {H}_{m} ) \times P ( {D}_{f} \vert {H}_{f} ) \times \\ P ( {D}_{c} \vert {H}_{c} ) \times P ( {H}_{m} ) \times P ( {H}_{f} ) \times \end{matrix} \\ M ( {H}_{c} \vert {H}_{m} , {H}_{f} )\end{matrix}}{\begin{matrix}\begin{matrix}\sum P ( {D}_{m} \vert {H}_{m} ) \times P ( {D}_{f} \vert {H}_{f} ) \times \\ P ( {D}_{c} \vert {H}_{c} ) \times P ( {H}_{m} ) \times P ( {H}_{f} ) \times \end{matrix} \\ M ( {H}_{c} \vert {H}_{m} , {H}_{f} )\end{matrix}} & ( Equation 4 )\end{matrix}$$

where:
P(H|D) is the probability of a hypothesis (H) being correct for all members given data D,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (H_{f}),
P(D_{c}|H_{c}) is the probability of the genomic sequence information for a child (D_{c}) occurring for the hypothesis for the child (H_{c}),
P(Hₘ) is the probability of the hypothesis occurring for the mother, independent of the data D,
P(H_{f}) is the probability of the hypothesis occurring for the father, independent of the data D,
M(H_{c}|Hₘ,H_{f}) is the Mendelian probability of the hypothesis for the child given the hypotheses for the parents, and
ΣP(Dₘ|Hₘ)×P(D_{f}|H_{f})×P(D_{c}|H_{c})×P(Hₘ)×P(H_{f})×M(H_{c}|Hₘ×H_{f}) is the sum of all probabilities over all possible combinations of hypotheses for the parent and child used to normalize probabilities.

De Novo Mutations

The Mendelian probability of the hypothesis for the child given the hypotheses for the parents M(H_{c}|Hₘ, H_{f}) may be a simple Mendelian probability or may be a modified form that takes into account non-Mendelian mechanisms. In particular the probabilities associated with de novo mutations may be incorporated into the Mendelian probability M(H_{c}|Hₘ, H_{f}).

In certain embodiments, the probability of de novo mutations may be influenced by population factors (such as species information and the age of the parents), and environmental factors (such as radiation exposure, feed sources, climatic conditions, etc).

One way of constructing a modified Mendelian table M′(H_{c}|Hₘ, H_{f}) is to assume that there is some small probability g of a single nucleotide being mutated and that both nucleotides are never mutated at the same time (because g can be very small). Then the various values in M′ can be computed from the original M. For example:

M′(A:C|A:A,A:A)=2μ/3×M(A:A|A:A,A:A)

M′(A:A|A:A,A:A)=(1−2μ)×M(A:A|A:A,A:A)

In this way even though the probability of a de novo mutation may be very low, information across a family may be utilized to reveal the significance of anomalous data in a subject that may reveal a de novo mutation. A de novo mutation may be identified where the probability of an hypothesis for a de novo mutation is greater than for any other hypothesis or according to other prescribed criteria. In some cases a likelihood of a de novo mutation above a certain level may be flagged so that the region of interest may be further analyzed.

Contamination

In certain embodiments, a sample is obtained from a location expected to have predominantly normal genomic material (e.g. a blood sample) and another is obtained from a region where it is suspected that cancerous genomic material is present. The two samples are sequenced by a sequencing machine to produce sets of reads for each sample. It will be appreciated that genomic sequence information (either reads or a sequence listing) for a prior normal sample may advantageously be utilized where available. Alternatively in some cases a reference genome (such as a reference human genome) may be utilized (for example where the region of investigation is relatively uniform in humans).

In certain embodiments that apply a Bayesian model to calling a genomic sequence, the probability of a hypothesis (proposed sequence values for the region of interest) being correct given the data (reads) is the normalized value of the probability of the hypothesis occurring (prior) times the probability of the data occurring given the hypothesis (model). In certain embodiments a Bayesian model is used to compare two genomes, a normal genome (for which the subscript n is used) and a cancer genome (for which the subscript c is used). Hypotheses can be generated for the pair Hₙ,H_{c} (i.e. hypotheses as to the sequences values for a region of interest for the normal and cancerous genome) and the evidence will be a pair Eₙ, E_{c} (i.e. the reads for the cancerous and normal sample in the region of interest, or simply the portions of the normal sequence where a sequence listing is available).

$$P ( {H}_{n} , {H}_{c} \vert {E}_{n} , {E}_{c} ) = \frac{P ( {E}_{n} , {E}_{c} \vert {H}_{n} , {H}_{c} ) \times P ( {H}_{n} , {H}_{c} )}{P ( E )} \qquad ( Equation 5 )$$

where P(E) is the cumulative value of the probability for all hypotheses to normalize the probability measure.

The “priors” (i.e. probability of a hypothesis occurring) may be obtained in a variety of ways. As outlined above P(H) may be obtained from, for example, a reference listing of the human genome, from a prior sequencing and/or from contemporaneous sequencing of the normal sample. P(H_{c}) may be obtained from, for example, reference listings of known cancer sequences. In certain embodiments P(H_{c}) is not a required term.

The hypotheses may be the reads for each sample.

Assuming no contamination:

P(Eₙ,E_{c}|Hₙ,H_{c})=P(Eₙ|Hₙ)P(E_{c}|H_{c})

That is, certain embodiments can use the posteriors (before applying priors) for the individual genomes from the calculations that are normally done for SNP (single-nucleotide polymorphism) calling. To compute the priors one can use a model where H_{c} is taken as being a mutation from an original normal hypothesis, and then:

P(Hₙ,H_{c})=P(Hₙ)Q(H_{c}|Hₙ)

where Q(H_{c}|Hₙ) is the probability of a transition from Hₙ to H_{c}. In certain embodiments this can be computed as a table given μ, the probability of a novel mutation on one of an homologous pair of chromosomes from the normal to cancer genome.

For example in the haploid case:

Q(C|A)=μ/3

Q(A|A)=1−μ

In the diploid case:

Q(XX|UV)=Q(X|U)Q(X|V)

Q(XY|UV)=Q(X|U)Q(Y|V)+Q(Y|U)Q(X|V)where X≠Y

In certain circumstances there is a non-zero probability that there will be an LOH (loss of heterozygosity) event on the cancer side. Sometimes it will be known from other analyses that this has happened and other times it can only be estimated as a general probability. Given LOH the calculation for Q is:

Q(XX|UV)=[Q(X|U)+Q(X|V)]/2

For complex calling, the individual transition Q(X|U) can be estimated using the technique described in U.S. Appl. 61/695,408 (which is hereby incorporated by reference) where the sequence X is matched against the sequence U and the transitions are normalized for a given U. It may be advantageous to include part of the reference on either side of the sequences to allow some correction when there are repeat or homopolymer regions.

Combining these formulae, we have:

$$\begin{matrix}P ( {H}_{n} , {H}_{c} \vert {E}_{n} , {E}_{c} ) = \frac{P ( {E}_{n} , {E}_{c} \vert {H}_{n} , {H}_{c} ) P ( {H}_{n} ) Q ( {H}_{c} , {H}_{n} )}{P ( E )} & ( Equation 6 ) \\ = \frac{P ( {E}_{n} \vert {H}_{n} ) P ( {E}_{c} \vert {H}_{c} ) P ( {H}_{n} ) Q ( {H}_{c} \vert {H}_{n} )}{P ( E )} & ( Equation 7 )\end{matrix}$$

To account for contamination of the cancer sample by normal DNA, the following modification can be included:

$$P ( {E}_{n} , {E}_{c} \vert {H}_{n} , {H}_{c} ) = P ( {E}_{n} \vert {H}_{n} ) P ( {E}_{c} \vert {H}_{n} , {H}_{c} )$$

$$P ( {E}_{n} , {H}_{n} ) = {\prod }_{{e}_{n} ∈ {E}_{n}} P ( {e}_{n} \vert {H}_{n} )$$

$$P ( {E}_{c} \vert {H}_{n} , {H}_{c} ) = {\prod }_{{e}_{c} ∈ {E}_{c}} P ( {e}_{c} \vert {H}_{n} , {H}_{c} )$$

and then assuming a is an estimate of the fraction of the cancer sample which is in fact normal tissue we have:

P(e_{c}|Hₙ,H_{c})=αP(e_{c}|Hₙ)+(1−α)P(e_{c}|H_{c}) (Equation 8)

The contamination value a may be determined by, for example:

(1) Expert determination by a clinician based on clinical factors and experience;

(2) Clinical information—using an appropriate formula, an expert system, neural network, learning system, or the like;

(3) Comparison of “SNP chips”—for example, compare the number of reads for an area of the sequence likely to give a good indication of relative proportions of normal and cancerous material;

(4) An optimization technique whereby a probability, for example the global probability, is maximized as the measure of goodness.

Combining the above this gives:

$$P ( {H}_{n} , {H}_{c} \vert {E}_{n} , {E}_{c} ) = \frac{P ( {E}_{n} \vert {H}_{n} ) P ( {E}_{c} \vert {H}_{n} , {H}_{c} ) P ( {H}_{n} ) Q ( {H}_{c} \vert {H}_{n} )}{P ( E )} \qquad ( Equation 9 )$$

In certain embodiments, P(E_{c}|Hₙ,H_{c}) is accumulated for all the pairs Hₙ,H_{c}, which imposes a significantly greater burden than computing P(Eₙ|Hₙ) and P(E_{c}|H_{c}) separately. One strategy that may be employed is to first compute without using contamination and then in cases where it seems that there may be a non-trivial case, to perform the full calculation.

Copy Number

In a tumor (and in other types of biological samples) the number of copies of a region may differ from that in the normal genome. This can be modeled by assuming that the total number of copies in the tumor is n and that the number of copies of one of an homologous pair of chromosomes is a and of the other is b, that is n=a+b. A special case that is of interest are regions of loss of heterozygosity. This occurs, for example, when the normal genome had a copy number of 2 and the tumor has a copy number of 1—that is, n=1 and a=1, b=0 (or vice versa).

When a # b, a diploid hypothesis is no longer agnostic about orientation, that is the hypothesis AC differs from CA. To deal with this the tumor hypothesis ft may be broken down into a pair H′_{c} and H″_{c} for each haploid hypothesis. For example, for simple SNP calls there can be 16 possible hypotheses rather than the normal 10. The set of hypotheses is given by H_{c}=H′_{c}×H″_{c}.

According to this embodiment, the formula that includes the effect of both contamination and copy number is:

$$P ( {e}_{c} \vert {H}_{n} , {H}_{c} ) = P ( {e}_{c} \vert {H}_{n} , {H}_{c}^{′} , {H}_{c}^{″} ) = α P ( {e}_{c} \vert {H}_{n} ) + ( 1 - α ) ( a / ( a + b ) P ( {e}_{c} \vert {H}_{c}^{′} ) + b / ( a + b ) P ( {e}_{c} \vert {H}_{c}^{″} ) ) \qquad ( equation 10 )$$

The copy number values a and b may be calculated in a variety of ways including:

(1) Based on the total number of reads associated with the normal biological sample and the number of reads associated with the cancerous biological sample;

(2) Based on the number of reads associated with the normal biological sample and the number of reads associated with the cancerous biological sample at a plurality of selected locations;

(3) Based on the number of reads associated with the normal biological sample and the number of reads associated with the cancerous biological sample at a location known to be particularly distinctive for one of the sequences.

It will be appreciated that the modification to accommodate copy number variation may be used independently of the modification for dealing with contamination and/or de novo mutations, as well as other aspects of the embodiments disclosed herein. The copy number variation techniques may be applied advantageously to better call cancer-related and other biological sequences irrespective of contamination.

Certain embodiments thus provide sequence calling methods using information for both normal and cancerous samples to provide high quality calls to be made with consistent scoring. The models can provide fast resolution of complex calling problems with improved accuracy. There is provided accurate calling of normal and cancerous sequences for mixed samples and methods of handling copy number variation.

Pruning

The probability of an hypothesis occurring (P(Hₘ), P(H_{f}) etc) may be based on historical sequence information, e.g., comparing the sequence in the area of interest with published sequence information (such as the 1000 Genomes Project or dbSNP) in the area of interest that is the probability of that sequence occurring, irrespective of the read data.

The possible hypotheses may include, for example:

(1) All possible sequences for the region of interest. This is generally the most processing intensive approach and may be most appropriate where deep investigation of a region is required or the sequence length is short.

(2) All read values occurring in the region of interest. It is unlikely that a sequence value not occurring in any read will be the correct value and so this approach limits computation without significant reduction in calling confidence.

(3) Read values above may be combined with “assemblies of reads”. Such “assemblies of reads” may combine “associated reads”. This association may be, for example, paired end reads or reads that are associated with external reference sequences (i.e. “pseudo reads” from publications or external events; not from “wet” reads from a sequencer). Such assembled reads may be combined across multiple samples.

The above hypotheses may be pruned using techniques including removing a hypothesis where, for example:

(1) the number of reads matching the hypothesis is below a threshold level;

(2) the occurrence of the hypothesis in historic data for the type of genomic sequence is below a threshold level; and/or

(3) the hypothesis breaches Mendelian inheritance rules.

In some situations pruning is not appropriate.

Hypotheses may also be evaluated in a prescribed order. This may be based on a weighting of hypotheses. The weighting of hypotheses may be a graduated scale or on a simple inclusion and exclusion basis. The weighting may be based upon the frequency of occurrence of a hypothesis in the sequence values and the hypotheses may be evaluated from the hypotheses having the highest weighting to those having the lowest weighting. Sex-based inheritance may also be taken into account. Evaluation may be terminated before all hypotheses are evaluated if an acceptance criterion is met. The acceptance criteria may be that a hypothesis is found to have a probability above a threshold value or be based on a trend in probabilities from evaluation (e.g. continually decreasing probabilities of hypotheses).

Model values (such as P(Dₘ|Hₘ)) represent the probability of the genomic sequence information (e.g. (Dₘ) for a mother) occurring given the hypothesis (e.g. (Hₘ) for the mother). These model values may be calculated on the basis of one or more of:

(1) quality scores for sequencing machines (i.e. the figures as to sequencing accuracy published by sequencing machine manufacturers);

(2) calibrated quality scores (i.e. quality figures determined from preliminary alignment);

(3) mapping scores (such as MAPQ scores); and/or

(4) the chemistry of the sequences (there may be different probabilities of error, insertion, deletion, etc. depending upon the particular sequence values).

Hypotheses may be processed in an order considered most likely to produce a call meeting a required confidence level. Hypotheses may be rated according to factors such as their frequency of occurrence in the reads, a rating score (such as a MAPQ value) etc. Processing may be terminated if a hypothesis probability is above a threshold value or is trending in a desired manner. This is a technique to speed up processing and may not be appropriate where a more detailed evaluation is required.

Expectation maximization techniques may also be employed, as discussed above, to further refine calling. For example, priors may initially be based on sequence information for a known population. Family sequences may be called using the methodology described above. The family sequences may then be added to the priors and the family sequences recalled. This may be repeated until an acceptable convergence is achieved.

FIG. 2 illustrates a larger pedigree of six family members. In this case:

H=Hₘ×H_{f}×ΠHᵢ

P(H)=P(Hₘ,H_{f},ΠHᵢ)=P(Hₘ)×P(H_{f})×ΠM(Hᵢ|Hₘ,Hₜ)

P(D|H)=P(Dₘ|Hₘ)×P(D_{f}|H_{f})×ΠP(Dᵢ|Hᵢ)

The resulting equation is:

$$P ( H \vert D ) = \frac{\begin{matrix}\begin{matrix}P ( {H}_{m} ) \times P ( {H}_{f} ) \times Π M ( {H}_{i} \vert {H}_{m} , {H}_{f} ) \times \\ P ( {D}_{m} \vert {H}_{m} ) \times P ( {D}_{f} \vert {H}_{f} ) \times \end{matrix} \\ Π P ( {D}_{i} \vert {H}_{i} )\end{matrix}}{\begin{matrix}\begin{matrix}\sum P ( {H}_{m} ) \times P ( {H}_{f} ) \times \\ Π M ( {H}_{i} , {H}_{m} , {H}_{f} ) \times P ( {D}_{m} \vert {H}_{m} ) \times \end{matrix} \\ P ( {D}_{f} \vert {H}_{f} ) \times Π P ( {D}_{i} \vert {H}_{i} )\end{matrix}} \qquad ( Equation 11 )$$

where:
P(H|D) is the probability of a hypothesis (H) being correct for all members given all the genomic sequence information (D),
P(Hₘ)×P(H_{f}) is the probability of the hypotheses for the mother and father occurring based on historical information,
ΠM(Hᵢ|Hₘ,H_{f}) is the Mendelian probability of the hypotheses for the i children given the hypotheses for the parents,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (H_{f}),
ΠP(Dᵢ|Hᵢ) is the probability of the genomic sequence information for the i children occurring for the hypotheses for the children, and
ΣP(Hₘ)×P(H_{f})×ΠM(Hᵢ|Hₘ,H_{f})×P(Dₘ|Hₘ)×P(D_{f}|H_{f})×ΠP(Dᵢ|Hᵢ) is the sum of all probabilities for all hypotheses.

It can be seen that for a family with 2 parents and n children that processing will be of the order of 10²⁺ⁿ. For very large families this may require substantial processing capacity.

Application of Forward-Backward Algorithms

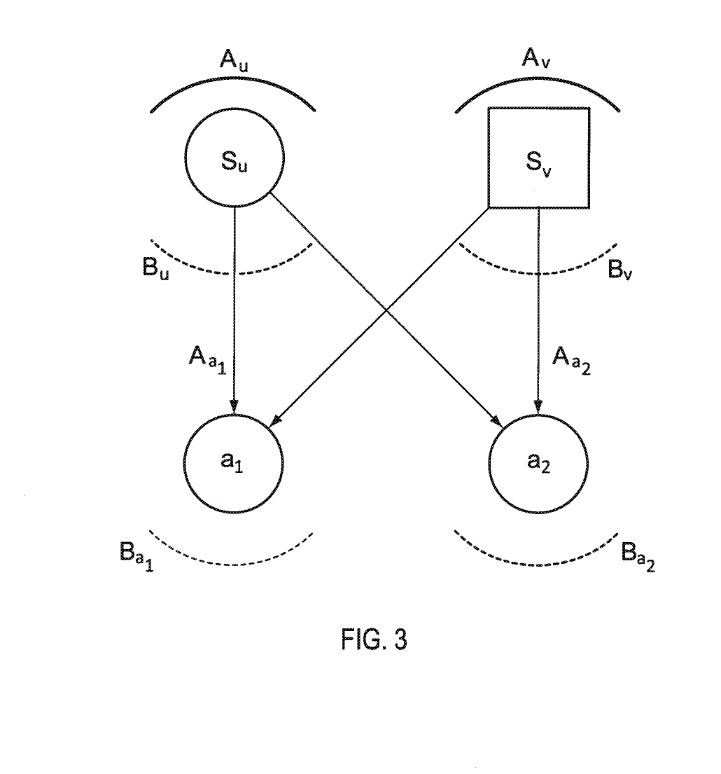

FIG. 3 illustrates a method of forward and backward propagation of values that is computationally more efficient for populations and large families. In certain embodiments of this process “A” values are calculated on the basis of the ancestors of each member (i.e. all members above a member in a generational representation). The A values are based on the members priors, the ancestor models above and Mendelian inheritance. These A values are propagated down to the generation below and affect the Priors for the generation below.

In certain embodiments, the “B” values are calculated on the basis of the Mendelian inheritance and the priors and models of the descendants below the member. The B values are propagated up to the generation above and affect the model for the parent.

In certain embodiments, the process may operate generally as follows:
(1) Calculate probabilities for each hypothesis for all members;
(2) Calculate A values and propagate these down to the generation below;
(3) Calculate B values and propagate these up to the generation above;
(4) Recalculate each hypothesis utilising each member's model and the propagated A and B values;
(5) Iterate forward and back through steps 2 to 4 until acceptable convergence is achieved. Acceptable convergence may be achieved when there is no further change during iterations or when an acceptable threshold has been met.

While for a single member just a single A value is propagated down, multiple B values may be propagated up and the recalculation will be based on the member's model, its A value, and all B values.

Where there is no genomic information for a population member, values may be inferred using this model. This enables the genomic sequences of population members to be called relatively accurately even where no or little genomic information is available.

Large Pedigrees

In certain embodiments, scores may be computed in a multi-genome variance caller to analyze genomic sequences corresponding to a large pedigree.

Large Pedigree Notation
a, b, c ranges over all children in a family
m, f index for mother and father respectively, in a family
u, v index for mother and father but leave unspecified which is which
h, i, j, k, l range over all possible hypotheses.
   j and k are paired respectively with u and v and f and m.
x range over all samples in pedigree.
A_{x,h} The “above” value for each sample.
B_{x,h} The “below” value for each sample (defined for monogamous families).
B_{x,y,h} The “below” value for each sample where y is the other parent.
B′_{x,y,h} Same as B_{x,y,h} but from the previous pass of the forward-backward algorithm.
S_{x,h}=The singleton posterior for each sample.
P(Dₓ|h)
M(h|j,k) Mendelian table (see multiScoring).
D Data for entire pedigree.
Dₓ Data for just the x'th sample.
H Hypotheses for entire pedigree.
Hₓ Hypotheses for just the x'th sample.
P(h) Prior.

Forward Backward Algorithm

Methods for approximating a Bayesian analysis for a large pedigree are included in the present disclosure.

In certain embodiments, a forward backward algorithm can be used to approximate the Bayesian analysis:

compute singleton model for all samples (P(Hₓ|Dₓ))
initialize Aₓ to priors and Bₓ to identities
do

compute priors

recompute Aₓ forward through pedigree
(start with founders)

recompute Bₓ backward through pedigree
(start with latest descendants)

recompute calls for each sample (P(Eₓ|h)P(h))

until no change in calls

For founding parents, Aₓ is the prior computed at the start or on each iteration. For individuals with no children, Bₓ is an identity where B_{x,h}=1.

Monogamous Family

Certain embodiments involve computing Ax for the children and Bx for the parents in a single family embedded inside a pedigree (see, e.g., FIG. 3). This assumes that all parents are monogamous, that is, belong to only one family (two parents and one or more children).

Exemplary formulae are:

$${A}_{a , h} = {\sum }_{j} {A}_{u , j} {S}_{u , j} {\sum }_{k} {A}_{v , k} {S}_{v , k} M ( h \vert j , k ) {\prod }_{b \neq a} {\sum }_{l} M ( l \vert j , k ) {S}_{b , l} {B}_{b , l} \\ {B}_{u , j} = {\sum }_{k} {A}_{v , k} {S}_{v , k} {\prod }_{b} {\sum }_{l} M ( l \vert j , k ) {S}_{b , l} {B}_{b , l} \\ P ( {D}_{x} \vert h ) P ( h ) = {A}_{x , h} {S}_{x , h} {B}_{x , h} \\ where h = {H}_{x} \qquad ( Equation 12 )$$

Non-Monogamous Families

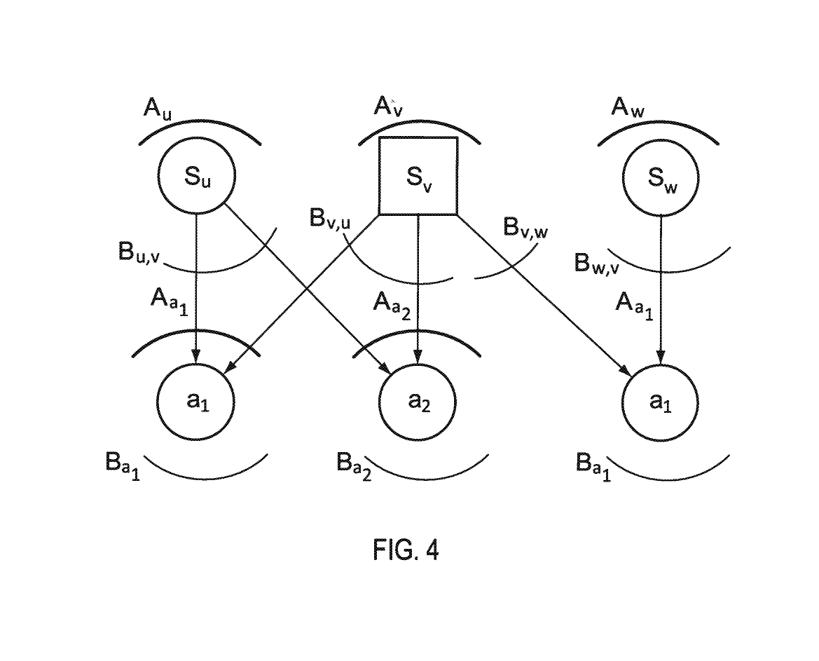

In certain embodiments, parents are not necessarily monogamous, that is, a parent can have children with more than one mate. See, e.g., FIG. 4.

Exemplary formulae are:

$${A}_{a , h} = {\sum }_{j} {A}_{u , j} {S}_{u , j} \{ {\prod }_{w \neq v} {B}_{u , w , j} \} {\sum }_{k} {A}_{v , k} {S}_{v , k} \{ {\prod }_{w \neq u} {B}_{v , w , k} \} \times M ( h \vert j , k ) {\prod }_{b \neq a} {\sum }_{l} M ( l \vert j , k ) {S}_{b , l} {\prod }_{w} {B}_{b , w , l} \\ {B}_{u , v , j} = {\sum }_{k} {A}_{v , k} {S}_{v , k} \{ {\prod }_{w \neq u} {B}_{v , w , k}^{′} \} {\prod }_{b} {\sum }_{l} M ( l \vert j , k ) {S}_{b , l} {\prod }_{w} {B}_{b , w , l} \\ P ( {E}_{x} \vert h ) P ( h ) = {A}_{x , h} {S}_{x , h} {\prod }_{w} {B}_{x , w , h} \\ where h = {H}_{{x}^{*}} \qquad ( Equation 13 )$$

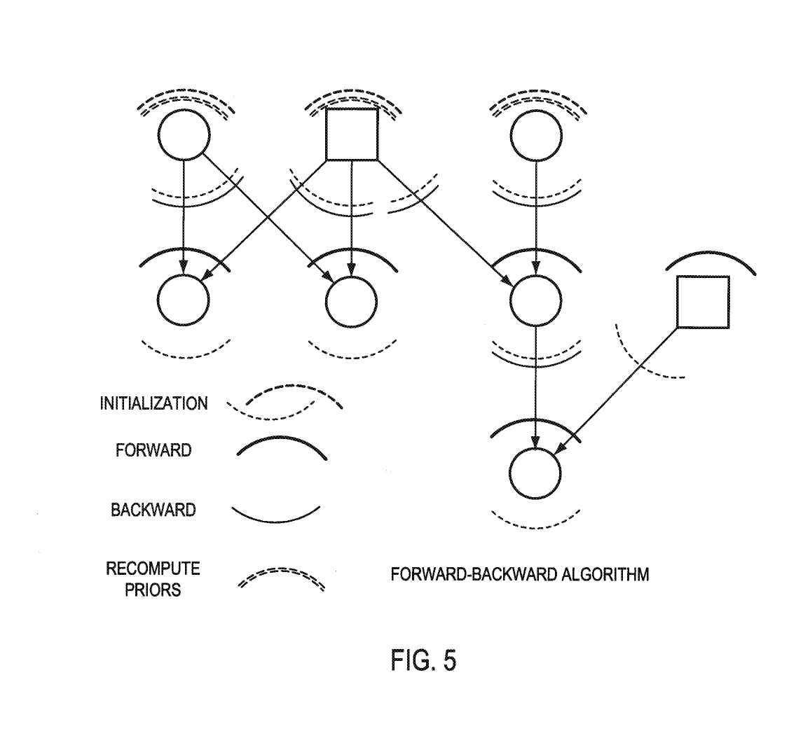

The order of execution can be straightforward in the forward direction. Execution order may be organized as a directed graph where there are directed arrows from each parent to its children. See, e.g., FIG. 5. This is guaranteed to be acyclic because conception is a causal operation. This is true for both monogamous and non-monogamous families.

The backward direction requires arrows from children to parents but also between half-siblings. The result is acyclic when the families are monogamous. However, in the presence of non-monogamous families it is possible to end up with cycles in the graph. One can ignore this and just use the most recent values of Bₓ at each step, unfortunately, the results depend on the order that nodes are visited. The solution above is to use the values of B from the previous generation (B′_{v,w,k}).

This approach can be computationally efficient for large families and provides improved calling for individuals with no or little coverage.

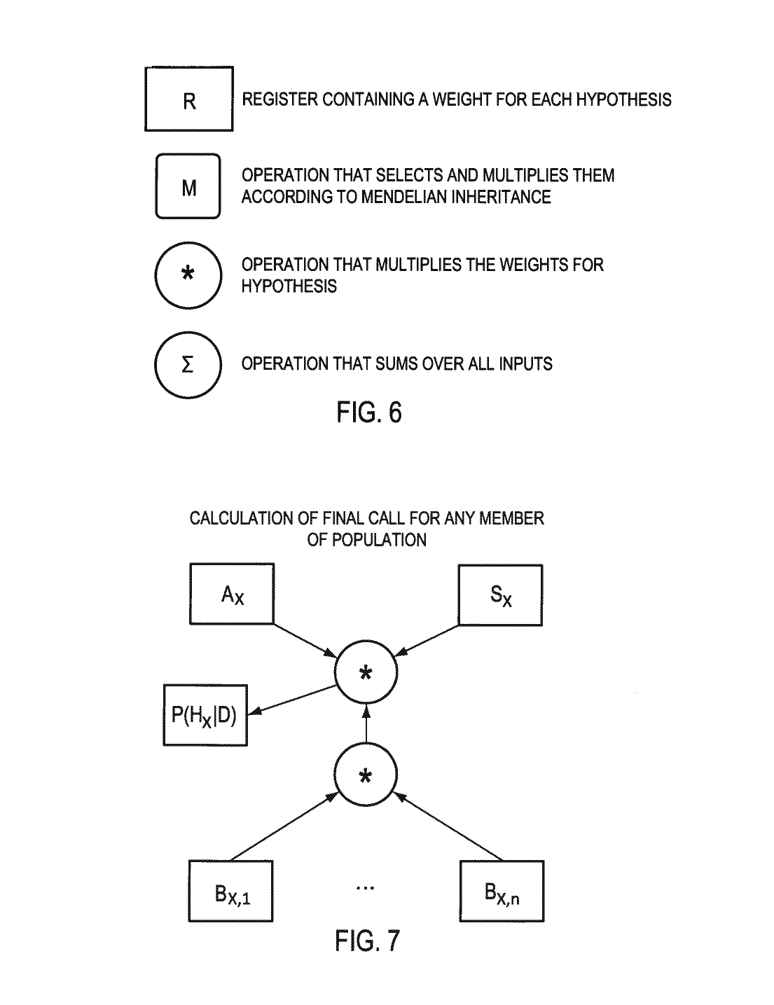

FIGS. 6 to 9 exemplify possible hardware implementation that may embody aspects of this method.

Exemplary hardware components are represented in FIG. 6, including registers that store one weight for each hypothesis, and computational units that multiply the weights of hypotheses, sum over weights and select weights according to the rules of Mendelian inheritance.

FIG. 7 shows the hardware components that can be used to compute the final normalized probabilities of the hypotheses (P(Hₓ|D)).

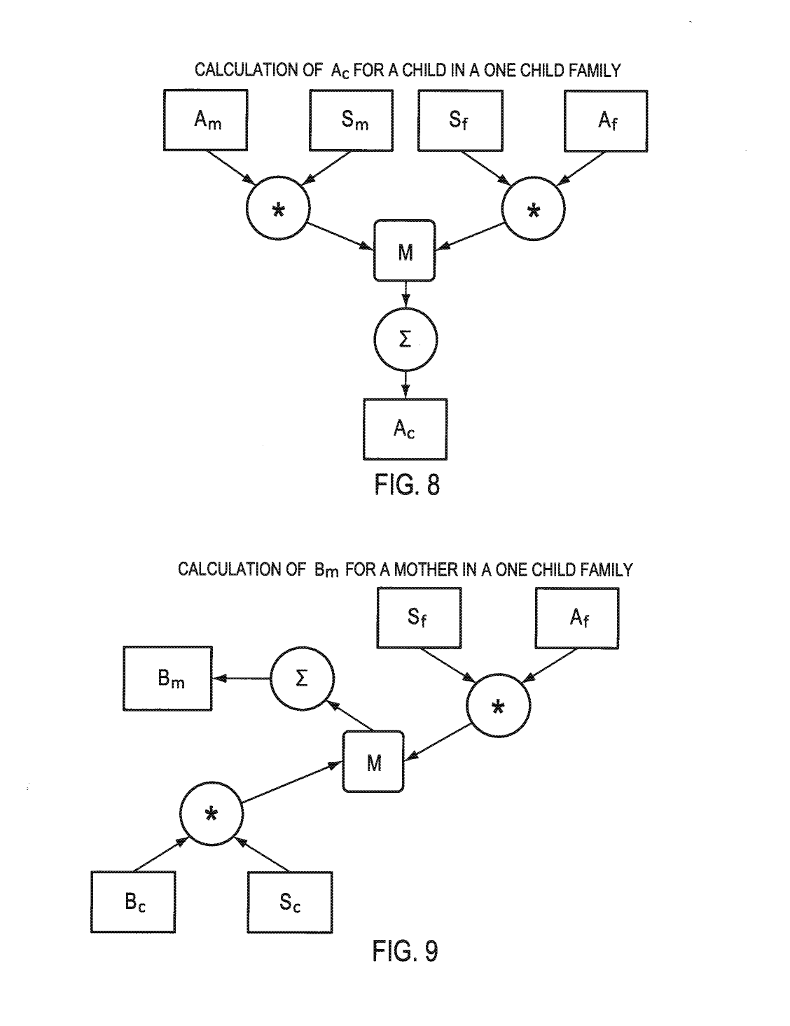

FIG. 8 shows the hardware that computes the A_{c} value for a child in a single child family. This example takes as inputs the A values and S values for the parents.

FIG. 9 shows the hardware that computes the Bₘ value for a mother in a single child family. This example takes as inputs the A values and S values for the father and the child.

Due to the large number of variant calling possibilities at each location in a genome, there may be benefit in using a specific hardware implementation utilizing parallel execution. Such hardware may dramatically increase the speed of the pedigree variant analysis.

In such a specific hardware solution a set of reads may be passed to the hardware device covering a fixed range across the genome. For example, given a window of, say 20, nucleotides across a chromosome, a set of reads that map to that location may be analyzed by the hardware device.

The pedigree information may also be provided with respect to each read. The hardware devices in parallel can update the thousands or hundreds of thousands of possible variants in parallel and a result obtained that maximizes a likelihood function.

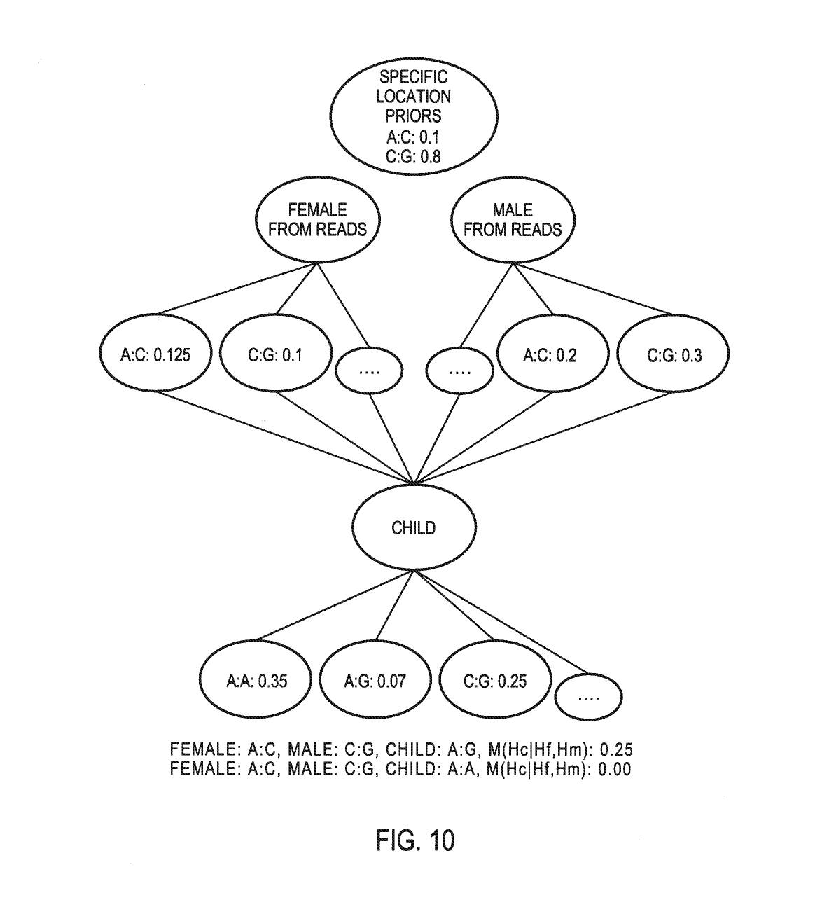

The possible variants can be designed as part of a neural network that efficiently updates counts and probabilities as more read-based evidence is supplied. An example representing a hardware device to provide real-time pedigree variant analysis is shown in FIG. 10.

As would be well understood by those of skill in the art, the disclosed methods may be performed by one or more processors executing program instructions stored on one or more memories. Certain embodiments comprise systems for calling genomic sequences, in which the system comprises one or more processors configured to execute one or more modules and a memory storing the one or more modules, wherein the modules comprise the exemplary hardware components disclosed above.

There are thus provided methods utilizing population and family information to provide high quality calls to be made with consistent scoring. The models provide a principled way of combining multiple effects with the ability to dynamically update model values as information increases. The models provide fast resolution of complex calling problems with improved accuracy.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

### EXAMPLES

The following specific examples are to be construed as merely illustrative, and not limiting of the disclosure.

### Example 1

### Bayesian Calling for Haploid Genome

Table 1 below provides an example illustrating the application of the invention to a haploid genome. Applying a Bayesian model to calling a genomic sequence the probability of a hypothesis (proposed sequence values for the region of interest) being correct given the data (reads) is the normalized value of the probability of the hypothesis occurring (prior) times the probability of the data occurring given the hypothesis (model) which may be expressed as described in Equation 1, repeated here:

$$P ( H \vert D ) = \frac{P ( H ) \times P ( D \vert H )}{\sum P ( H ) \times P ( D \vert H )} \qquad ( Equation 1 )$$

where:
P(H|D) is the probability of a hypothesis H being correct for all members given data D,
P(H) is the probability of the hypothesis occurring, independent of the data D,
P(D|H) the probability of the data D occurring given the hypothesis, and
ΣP(H)×P(D|H) is the sum of all probabilities for all hypotheses, which is used to normalize the results.

TABLE 1

| | P(H) | A | C | G | T |
|---|---|---|---|---|---|
| Hypotheses(H) | | 0.700000 | 0.100000 | 0.100000 | 0.100000 |
| (base) | | | | | |
| Evidence in | | | | | |
| Read (d) | | | | | |
| P(d\|H) | | | | | |
| A | | 0.900000 | 0.033333 | 0.033333 | 0.033333 |
| C | | 0.033333 | 0.900000 | 0.033333 | 0.033333 |
| G | | 0.033333 | 0.033333 | 0.900000 | 0.033333 |
| P(D\|H) | | 0.001000 | 0.001000 | 0.001000 | 0.000037 |
| P(D\|H)P(H) | | 0.000700 | 0.000100 | 0.000100 | 0.000004 |
| Σ P(D\|H)P(H) | 0.00090 | | | | |
| P(H\|D) | | 0.774590 | 0.110656 | 0.110656 | 0.004098 |

### Example 2

### Bayesian Calling for a Family

Table 2 below provides an example illustrating the application of the invention to a family. Where a family is being evaluated, such as illustrated in FIG. 1, Mendelian inheritance information may be incorporated into the model. Applying Equation 2 to a nuclear family of a mother (m) a father (f) and a child (c), it becomes:

$$\begin{matrix} P ( H \vert D ) = \frac{\begin{matrix}P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}}{\begin{matrix}\sum P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}} \\ which may be re \text{-} expressed as \text{:} & ( Equation 3 ) \\ P ( H \vert D ) = \frac{\begin{matrix}P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}}{\begin{matrix}\sum P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}} & ( Equation 4 )\end{matrix}$$

where:
P(H|D) is the probability of a hypothesis (H) being correct for all members given data D,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (Df) occurring for the hypothesis for the father (H_{f}),
P(D_{c}|H_{c}) is the probability of the genomic sequence information for a child (Dc) occurring for the hypothesis for the child (H_{c}),
P(Hₘ) is the probability of the hypothesis occurring for the mother, independent of the data D,
P(H_{f}) is the probability of the hypothesis occurring for the father, independent of the data D,
M(H_{c}|Hₘ,H_{f}) is the Mendelian probability of the hypothesis for the child given the hypotheses for the parents, and
ΣP(Dₘ|Hₘ)×P(D_{f}|H_{f})×P(D_{c}|H_{c})×P(Hₘ)×P(H_{f})×M(H_{c}|Hₘ×H_{f}) is the sum of all probabilities over all possible combinations of hypotheses for the parent and child used to normalize probabilities.

TABLE 2

| H | P(H) |
|---|---|
| A:C | 0.1 |
| C:G | 0.8 |
| . . . | |

| Hf | Hm | Hc | M(HC\|Hf, Hm) |
|---|---|---|---|
| A:C | A:C | A:C | 0.50 |
| A:C | C:G | A:G | 0.25 |
| A:C | C:G | A:A | 0.00 |
| . . . | | | |

| Father | | Mother | |
|---|---|---|---|
| Hf | P(Df\|Hf) | Hm | P(Dm\|Hm) |
| A:C | 0.125 | A:C | 0.2000 |
| C:G | 0.100 | C:G | 0.3000 |
| . . . | | | |

| Child | |
|---|---|
| Hc | P(Dc\|Hc) |
| A:A | 0.350 |
| A:G | 0.007 |
| C:G | 0.250 |
| . . . | |

| H | | | | | M(Hc\|Hf, | |
|---|---|---|---|---|---|---|
| Hf | Hm | Hc | P(D\|H) | P(Hf)P(Hm) | Hm) | P(D\|H)P(H) |
| A:C | C:G | A:G | 0.000263 | 0.080000 | 0.250000 | 0.00000525 |
| A:C | C:G | A:A | 0.013125 | 0.080000 | 0.000000 | 0.00000000 |

### Example 3

### Bayesian Calling for a Family Including De Novo Mutations

This example is identical to Example 2 except that it includes a probability of 0.01 in the M table for a de novo mutation of C:G to either A:G or C:A and then a selection of the de novo mutation in the child. The result is that a call that had a posterior probability of zero in Example 2 now has a posterior higher than the alternative call.

TABLE 3

| H | P(H) |
|---|---|
| A:C | 0.1 |
| C:G | 0.8 |
| . . . | |

| Hf | Hm | Hc | M(HC\|Hf, Hm) |
|---|---|---|---|
| A:C | A:C | A:C | 0.50 |
| A:C | C:G | A:G | 0.24 |
| A:C | C:G | A:A | 0.01 |
| . . . | | | |

| Father | | Mother | |
|---|---|---|---|
| Hf | P(Df\|Hf) | Hm | P(Dm\|Hm) |
| A:C | 0.125 | A:C | 0.2000 |
| C:G | 0.100 | C:G | 0.3000 |
| . . . | | | |

| Child | |
|---|---|
| Hc | P(Dc\|Hc) |
| A:A | 0.350 |
| A:G | 0.007 |
| C:G | 0.250 |
| . . . | |

| H | | | | | M(Hc\|Hf, | |
|---|---|---|---|---|---|---|
| Hf | Hm | Hc | P(D\|H) | P(Hf)P(Hm) | Hm) | P(D\|H)P(H) |
| A:C | C:G | A:G | 0.000263 | 0.080000 | 0.240000 | 0.00000504 |
| A:C | C:G | A:A | 0.013125 | 0.080000 | 0.010000 | 0.00001050 |

### EMBODIMENTS

The following embodiments are to be construed as merely illustrative, and not limiting of the disclosure,
1. A method of calling a genomic sequence for a population member comprising:
   a. obtaining genomic sequence information for one or more population members;
   b. performing read alignments to generate preliminary alignments for the population members;
   c. identifying a region of interest for the population member alignments;
   d. developing hypotheses as to sequence values in the region of interest; and
   e. evaluating the probability of one or more hypothesis being correct for a plurality of population members based on the genomic sequence information.
2. A method according to embodiment 1 comprising:
   a. obtaining genomic sequence information for one or more family members;
   b. obtaining genomic sequence information for a subject family member;
   c. performing read alignments to generate preliminary alignments for the family members;
   d. identifying a region of interest for the family member alignments;
   e. developing hypotheses as to sequence values in the region of interest; and
   f. evaluating the probability of one or more hypothesis being correct for the subject and the one or more family members taking into account Mendelian inheritance rules.
3. A method according to embodiment 2 wherein the probability of a hypothesis being correct for the subject and the one or more family members is dependent upon the probability of the hypothesis occurring, independent of the genomic sequence information; the probability of the genomic sequences occurring for the hypothesis; and Mendelian inheritance rules.
4. A method according to embodiment 2 or embodiment 3 wherein the probability of a hypothesis occurring is based on historical data.
5. A method according to embodiment 2 wherein the probability of one or more hypothesis being correct for the subject and the one or more family members is calculated according to:

$$P ( H \vert D ) = \frac{\begin{matrix}P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}{\begin{matrix}\sum P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}$$

where:
P(H|D) is the probability of a hypothesis (H) being correct for all members given all the genomic sequence information (D),
P(Hₘ)×P(H_{f}) is the probability of the hypotheses for the mother and father occurring based on historical information,
ΠM(Hᵢ|Hₘ, H_{f}) is the Mendelian probability of the hypotheses for the i children given the hypotheses for the parents,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (Hₜ),
ΠP(Di|Hi) is the probability of the genomic sequence information for the i children occurring for the hypotheses for the children, and
ΣP(Hₘ)×P(H_{f})×ΠM(Hᵢ|Hₘ, H_{f})×P(Dₘ|Hₘ)×P(D_{f}|H_{f})×ΠP(Dᵢ|Hᵢ) is the sum of all probabilities for all hypotheses.
6. A method according to embodiment 5 wherein the probability of genomic sequence information occurring for a hypothesis is dependent at least in part upon a quality score for a sequencing machine of a type that provided the genomic sequence information.
7. A method according to embodiment 5 wherein the probability of genomic sequence information occurring for a hypothesis is dependent at least in part upon calibrated quality scores for the family sequences.
8. A method according to embodiment 5 wherein the probability of genomic sequence information occurring for a hypothesis is dependent at least in part upon map scores assessing the quality of mapping of a hypothesis to a particular location of a reference sequence.
9. A method according to embodiment 5 wherein the probability of genomic sequence information occurring for a hypothesis is dependent at least in part upon the chemistry of the sequences.
10. A method according to any one of embodiments 2 to 9 wherein processing is conducted one nuclear family at a time.
11. A method according to embodiment 10 wherein processing includes a plurality of nuclear families having one or more common member.
12. A method according to embodiment 11 wherein one or more probabilities associated with one or more hypotheses for one nuclear family are utilized to calculate one or more probabilities associated with one or more hypotheses for a subsequent nuclear family.
13. A method according to embodiment 11 wherein one or more probabilities associated with one or more hypotheses for one nuclear family are utilized to calculate one or more probabilities associated with one or more hypotheses for a previous nuclear family.
14. A method according to embodiment 13 wherein the probabilities of one or more hypotheses are iteratively resolved by recalculation within nuclear families.
15. A method according to embodiment 11 wherein weightings for the probability of a hypothesis occurring are propagated forward through a family from the most senior to the most junior family member.
16. A method according to embodiment 11 or embodiment 15 wherein weightings for the probability of a genomic sequences occurring for the hypothesis are propagated back through a family from the most junior to the most senior family member.
17. A method according to any one of embodiments 14 to 16 wherein iterative resolution is continued until an acceptable convergence of probabilities is achieved.
18. A method according to any preceding embodiment wherein the order of evaluation of hypotheses is based on a weighting of hypotheses.
19. A method according to embodiment 18 wherein the weighting of hypotheses is on a graduated scale.
20. A method according to embodiment 19 wherein the weighting is at least in part dependent upon the frequency of occurrence of one or more sequence values.
21. A method according to embodiment 19 or embodiment 20 wherein hypotheses are evaluated from the hypotheses having the highest weighting to those having the lowest weighting.
22. A method according to embodiment 21 wherein processing is terminated if an acceptance criteria is met.
23. A method according to embodiment 22 wherein the acceptance criteria is a probability threshold.
24. A method according to embodiment 22 wherein the acceptance criteria is based on a trend in probabilities from evaluation.
25. A method according to embodiment 18 wherein hypotheses that do not comply with Mendelian inheritance rules are excluded.
26. A method according to any one of the preceding embodiments wherein hypotheses developed in step e of embodiment 2 are filtered.
27. A method as according to embodiment 26 wherein hypotheses having a frequency of occurrence below a threshold level are filtered out.
28. A method according to embodiment 26 wherein hypotheses having a low frequency of occurrence in similar populations from historic SNP data are filtered out.
29. A method according to any one of the preceding embodiments wherein the probability of an hypothesis occurring is iteratively resolved by:
   a. calling sequences for population members based on historical probability data as to the probability of an hypothesis occurring;
   b. combining the called sequences for population members with the historical probability data to produce combined historical data;
   c. re-calling sequences for population members based on the combined historical data as to the probability of an hypothesis occurring; and
   d. repeating steps b and c until a desired convergence is achieved.
30. A method according to embodiment 29 wherein in step b the called sequence information is combined with the historical probability data based on the probability of a haploid occurring.
31. A method according to embodiment 29 wherein in step b the called sequence information is combined with the historical probability data based on the probability of a diploid occurring.
32. A method according to any one of embodiments 29 to 31 wherein steps b and c are repeated until there is no change in sequence calling.
33. A method according to embodiment 1 wherein the probability of an hypothesis occurring is iteratively resolved by:
   a. calling sequences for population members based on historical probability data as to the probability of an hypothesis occurring;
   b. combining the called sequences for population members with the historical probability data to produce combined historical data;
   c. re-calling sequences for population members based on the combined historical data as to the probability of an hypothesis occurring;
   d. repeating steps b and c until a desired convergence is achieved.
34. A method according to embodiment 33 wherein in step b the called sequence information is combined with the historical probability data based on the probability of a haploid occurring.
35. A method according to embodiment 33 wherein in step b the called sequence information is combined with the historical probability data based on the probability of a diploid occurring.
36. A method according to any one of embodiments 33 to 35 wherein steps b and c are repeated until there is no change in sequence calling.
37. A method according to embodiment 3 when conducted for a plurality of members of a population further comprising the steps of:
   a. calculating the probability of each hypothesis for each member;
   b. calculating forward propagation values on the basis of a member and its ancestors and propagating these values down to the generation below;
   c. calculating backwards propagation values on the basis of a member and its descendants and propagating these values up to the generation above;
   d. recalculating each hypothesis utilising the forward and backwards propagation values; and
   e. repeating steps b to d until acceptable convergence is achieved.
38. A method according to embodiment 37 wherein acceptable convergence is reached when there is no further change between iterations.
39. A method according to embodiment 37 wherein acceptable convergence is reached when an acceptance criteria is met.
40. A method according to any one of embodiments 37 to 39 wherein the forward propagation values are based on each member's priors, the member model its ancestor models and Mendelian inheritance.
41. A method according to any one of embodiments 37 to 40 wherein the backwards propagation values are based on the member's priors, the member model, Mendelian inheritance and the models of its descendants.
42. A method according to any one of embodiments 37 to 41 wherein no genomic sequence information is available for a population member and its genomic sequence is called based on inferred values.
43. A method according to any one of the preceding embodiments wherein the genomic sequence information consists of sets of reads for each family member obtained from a sequencing machine.
44. A method according to any one of the preceding embodiments wherein the region of interest is a single sequence value.
45. A method according to any one of the preceding embodiments wherein the region of interest includes multiple sequence values.
46. A method according to any one of the preceding embodiments wherein the sequences are DNA sequences.
47. A method according to any one of the preceding embodiments wherein the sequences are RNA sequences.
48. A method according to any one of the preceding embodiments wherein the sequences are protein sequences.
49. A system for implementing the method of any one of the preceding embodiments.
50. A method according to any one of embodiments 1 to 18 wherein the genomic sequence information is a plurality of reads and at least some hypotheses are generated using an assembly of reads.
51. A method according to embodiment 50 wherein reads associated with aligned reads are included in an assembly of reads.
52. A method according to embodiment 51 wherein association includes matching paired end reads.
53. A method according to embodiment 50 wherein reads associated with external reference sequences are combined to form assemblies of reads.
54. A method according to embodiments 50-53 wherein the reads are combined across multiple samples.
55. A method according to any one of the preceding embodiments wherein the evaluation of an hypothesis includes evaluation of one or more non-Mendelian mechanisms that may cause a de novo mutation.
56. A method according to embodiment 55 wherein population factors are taken into account in the assessment of the probability of a de novo mutation.
57. A method according to embodiment 55 or embodiment 56 wherein environmental factors are taken into account in the assessment of the probability of a de novo mutation.
58. A method according to any one of the preceding embodiments when dependent upon embodiment 5 wherein the Mendelian probability of the hypothesis for the child given the hypotheses for the parents M(H_{c}|Hₘ, H_{f}) incorporates one or more probabilities associated with the likelihood of one or more non-Mendelian mechanisms causing a de novo mutation.

Additional embodiments include:
1. A computer implemented method of calling a genomic sequence for a sample from a subject potentially containing normal and cancerous material comprising:
   a. sequencing a potentially mixed sample of normal and cancerous genomic material to obtain reads for the sample;
   b. performing read alignment to generate preliminary read alignments for the sample;
   c. identifying a region of interest of the preliminary alignments;
   d. developing hypotheses as to sequence values in the region of interest; and
   e. evaluating the probability of normal sequence and cancerous sequence values based on the reads; normal genomic sequence information and a contamination factor.
2. A method according to embodiment 1 wherein the probability of normal sequence and cancerous sequence values for the subject is dependent upon the probability of the hypothesis occurring, independent of the reads; the probability of the reads occurring for the hypothesis; and a contamination factor.
3. A method according to embodiment 2 wherein the probability of a hypothesis that a sample contains cancerous and normal biological material is calculated according to:

$$P ( Hn , Hc \vert En , Ec ) = \frac{P ( En \vert Hn ) P ( Ec \vert Hn , Hc ) P ( Hn ) Q ( Hc \vert Hn )}{P ( E )}$$

where:
P(Hn,Hc|En,Ec) is the probability for a hypothesis as to normal (Hn) and cancerous (Hc) sequence values given the evidence (reads) for normal (En) and cancerous (Ec) samples

$$P ( En \vert Hn ) = {π}_{en ε En} P ( {e}_{n} \vert Hn )$$

$$P ( Ec \vert Hn , Hc ) = {π}_{ec ε Ec} P ( {e}_{c} \vert Hn , Hc )$$

$$P ( ec \vert Hn , Hc ) = α P ( ec \vert Hn ) + ( 1 - α ) P ( ec \vert Hc )$$

α is the contamination factor
P(Hₙ) is the probability of the normal hypotheses occurring based on reference information as to the normal genomic sequence,
Q(H_{c}|Hₙ) is the probability of a transition from Hn to Hc, and
P(E) is the sum of all probabilities for all hypotheses used to normalize the resulting probability.
4. A method according to any one of the preceding embodiments wherein the sample includes an homologous pair of chromosomes and the hypotheses include hypotheses for each of the homologous pair of chromosomes.
5. A method according to embodiment 4 wherein copy number weighting factors are associated with each of the homologous pair of chromosomes.
6. A method according to embodiment 5 wherein the probability of a hypothesis that a sample contains cancerous and normal biological material is calculated where:

P(Ec|Hn,Hc)=αP(ec|Hn)+(1−α)(a/(a+b)P(ec|H′c)+b/(a+b)P(ec|N′c))
where:
H′c is the hypothesis for one of an homologous pair of chromosomes
a is a weighting related to the number of copies of H′c
H″c is the hypothesis for the other one of the homologous pair of chromosomes
b is a weighting related to the number of copies of H″c
7. A method according to embodiment 5 or embodiment 6 wherein copy numbers are estimated based on the total number of reads in a normal sample and the number of reads in a potentially cancerous sample.
8. A method according to embodiment 5 or embodiment 6 wherein copy numbers are estimated at a plurality of locations based on the number of reads in a normal sample and the number of reads in a potentially cancerous sample after alignment.
9. A method according to embodiment 5 or embodiment 6 wherein copy numbers are estimated at a location where a normal or target cancerous sequence is known to have a distinctive sequence based on the number of reads in a normal sample and the number of reads in a potentially cancerous sample.
10. A method according to any one of the preceding embodiments wherein a region of interest is a complex calling region.
11. A method according to any one of the preceding embodiments wherein the hypotheses are the reads occurring in the region of interest.
12. A method according to any one of the preceding embodiments wherein the hypotheses include known cancerous sequences.
13. A method according to any one of the preceding embodiments wherein normal genomic sequence information is obtained from sequencing a sample from the subject considered likely to contain only normal genomic sequence information.
14. A method according to any one embodiments 1 to 12 wherein normal genomic sequence information is obtained from a human genome reference source.
15. A method according to any one embodiments 1 to 12 wherein normal genomic sequence information is obtained from sequencing a sample of the subject at a prior time.
16. A method according to any one of the preceding embodiments wherein the contamination factor is based on an expert determination.
17. A method according to any one of embodiments 1 to 15 wherein the contamination factor is based on clinical information.
18. A method according to any one of embodiments 1 to 15 wherein the contamination factor is based on a comparison of the ratio of normal and cancerous genomic sequence values in one or more specified regions.
19. A method according to embodiment 18 wherein the specified region is selected based on distinctiveness the normal and cancerous genomic sequences in the specified region.
20. A method according to any one of embodiments 1 to 15 wherein the contamination factor is determined using an optimization process.
21. A method according to embodiment 20 wherein the global probability is used as the measure of goodness for the optimization process.
22. A computer implemented method of calling a genomic sequence for a sample including diploid genetic sequences potentially containing normal and cancerous material comprising:
   a. sequencing the sample of potentially normal and cancerous genomic material to obtain reads for the sample;
   b. performing read alignment to generate preliminary read alignments for the sample;
   c. identifying a region of interest of the preliminary alignments;
   d. developing hypotheses as to sequence values for each of the homologous pair of chromosomes in the region of interest; and
   e. evaluating the probability of normal sequence and cancerous sequence values based on the reads; normal genomic sequence information and copy number weighting factors associated with each of the homologous pair of chromosomes.
23. A method of calling a genomic sequence for a sample from a biological entity in a collection of related biological entities, performed by one or more processors executing program instructions stored on one or more memories, causing the one or more processors to perform the method comprising:
   a. obtaining genomic sequence information for one or more samples from one or more biological entities;
   b. performing read alignments to generate preliminary alignments for the samples;
   c. identifying a region of interest for the alignments;
   d. developing hypotheses as to sequence values in the region of interest; and
   e. evaluating the probability of one or more hypothesis being correct for a plurality of sequence values based on the genomic sequence information.
24. The method of embodiment 23, wherein the evaluation of an hypothesis incorporates the possibility of de novo mutations.
25. The method of embodiment 24, wherein population factors are taken into account in the assessment of the probability of de novo mutations.
26. The method of embodiment 24, wherein environmental factors are taken into account in the assessment of the probability of de novo mutations.

Other embodiments of the invention will be apparent to those skilled in the art from consideration of the specification and practice of the invention disclosed herein. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept. It is intended that the specification and examples be considered as exemplary only, with a true scope and spirit of the invention being indicated by the following claims.

What is claimed is:

1. A method of calling a genomic sequence for a sample from a biological entity in a collection of related biological entities, performed by one or more processors executing program instructions stored on one or more memories, causing the one or more processors to perform the method comprising:
a. obtaining genomic sequence information for one or more samples from one or more biological entities;
b. performing read alignments to generate preliminary alignments for the samples;
c. identifying a region of interest for the alignments;
d. developing hypotheses as to sequence values in the region of interest; and
e. evaluating the probability of one or more hypothesis being correct for a plurality of sequence values based on the genomic sequence information.

2. The method of claim 1, wherein the step of evaluating the probability of one or more hypothesis being correct incorporates Mendelian inheritance rules.

3. The method of claim 1, wherein the probability of a hypothesis occurring is based on historical data.

4. The method of claim 2, wherein the probability of one or more hypothesis being correct for is calculated according to:
$$P ( H \vert D ) = \frac{\begin{matrix}P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}{\begin{matrix}\sum P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}$$
where:
P(H|D) is the probability of a hypothesis (H) being correct for all members of the collection given all the genomic sequence information (D),
P(Hₘ)×P(H_{f}) is the probability of the hypotheses for a mother and father occurring based on historical information,
ΠM(Hᵢ|Hₘ, H_{f}) is the Mendelian probability of the hypotheses for i children given the hypotheses for the parents,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (H_{f}),
ΠP(Dᵢ|Hᵢ) is the probability of the genomic sequence information for the i children occurring for the hypotheses for the children, and
ΣP(Hₘ)×P(H_{f})×ΠM(Hᵢ|Hₘ, H_{f})×P(Dₘ|Hₘ)×P(D_{f}|H_{f})×ΠP(Dᵢ|Hᵢ) is the sum of all probabilities for all hypotheses.

5. The method of claim 1, wherein the probability of genomic sequence information occurring for a hypothesis is dependent at least in part upon a quality score for a sequencing machine of a type that provided the genomic sequence information.

6. The method of claim 1, wherein one or more sample is obtained from a patient.

7. The method of claim 1, wherein one or more sample is obtained from a SNP chip.

8. The method of claim 1, wherein the probability of genomic sequence information occurring for a hypothesis is dependent at least in part upon map scores assessing the quality of mapping of a hypothesis to a particular location of a reference sequence.

9. The method of claim 1, wherein processing is conducted one nuclear family at a time, and wherein one or more probabilities associated with one or more hypotheses for one nuclear family are utilized to calculate one or more probabilities associated with one or more hypotheses for a subsequent nuclear family.

10. The method of claim 1, wherein the order of evaluation of hypotheses is based on a weighting of hypotheses.

11. The method of claim 1, wherein the hypotheses developed in step d are pruned.

12. The method of claim 1, wherein the probability of an hypothesis occurring is iteratively resolved by:
a. calling sequences for collection members based on historical probability data as to the probability of an hypothesis occurring;
b. combining the called sequences for collection members with the historical probability data to produce combined historical data;
c. re-calling sequences for collection members based on the combined historical data as to the probability of an hypothesis occurring;
d. repeating steps b and c until a desired convergence is achieved.

13. The method of claim 1, further comprising the steps of:
a. calculating the probability of each hypothesis for each collection member;
b. calculating forward propagation values on the basis of a member and its ancestors and propagating these values down to the generation below;
c. calculating backwards propagation values on the basis of a member and its descendants and propagating these values up to the generation above;
d. recalculating each hypothesis utilising the forward and backwards propagation values; and
e. repeating steps b to d until acceptable convergence is achieved.

14. The method of claim 1, wherein no genomic sequence information is available for a collection member and its genomic sequence is called based on inferred values.

15. The method of claim 1, wherein the genomic sequences are DNA sequences or RNA sequences.

16. A system for calling a genomic sequence for a sample from a biological entity in a collection of related biological entities, the system comprising:
one or more processors configured to execute one or more modules; and
a memory storing the one or more modules, the modules comprising:
a. code for obtaining genomic sequence information for one or more samples from one or more biological entities;
b. code for performing read alignments to generate preliminary alignments for the samples;
c. code for identifying a region of interest for the alignments;
d. code for developing hypotheses as to sequence values in the region of interest; and
e. code for evaluating the probability of one or more hypothesis being correct for a plurality of sequence values based on the genomic sequence information.

17. A method of calling a genomic sequence for a sample from a subject potentially containing normal and cancerous material, performed by one or more processors executing program instructions stored on one or more memories, causing the one or more processors to perform the method comprising:
a. sequencing the potentially mixed sample of normal and cancerous genomic material to obtain reads for the sample;
b. performing read alignments to generate preliminary alignments for the samples;
c. identifying a region of interest for the alignments;
d. developing hypotheses as to sequence values in the region of interest; and
e. evaluating the probability of normal sequence and cancerous sequence values based on the reads, normal genomic sequence information, and a contamination factor.

18. The method of claim 17, wherein the sample includes a homologous pair of chromosomes, and the hypotheses include hypotheses for each of the homologous pair of chromosomes, and wherein copy number weighting factors are associated with each of the homologous pair of chromosomes.
